(19) United States
(12) Patent Application Publication
(10) Pub. No.: US 2018/0143029 A1
(43) Pub. Date: May 24, 2018

(54) INTELLIGENT SYSTEM AND METHOD FOR ROUTE PLANNING

(71) Applicant: Faraday&Future Inc., Gardena, CA (US)

(72) Inventors: Serge Nikulin, San Jose, CA (US); Jan Becker, Palo Alto, CA (US)

(21) Appl. No.: 15/636,192

(22) Filed: Jun. 28, 2017

Related U.S. Application Data
(60) Provisional application No. 62/355,833, filed on Jun. 28, 2016.

(51) Int. Cl. G01C 21/34; G01C 21/36

(52) U.S. Cl. CPC G01C 21/3469; G01C 21/3415; G06Q 30/016; G01C 21/3484; G01C 21/3697

(57) ABSTRACT

The present disclosure describes a system for vehicles that detects and gathers information about of a vehicle to determine a route that accounts for charging a vehicle. The system is configured to obtain remaining charge of a battery, identify present occupants of the vehicle, obtain characteristics of the occupants, identify charging stations located between present location of the vehicle and the specified destination, obtain characteristics of the charging stations, and determining a route for the vehicle to the specified destination based on the remaining charge of the battery, the characteristics of the present occupants, and the characteristics of the charging stations. The system can also determine routes without a specified destination. This includes alerting for low charge and providing range estimates so that the vehicle remains within range of a charging station.

### CROSS-REFERENCE TO RELATED APPLICATIONS

This application claims the benefit of U.S. Provisional Application No. 62/355,833, filed Jun. 28, 2016, the entirety of which is hereby incorporated by reference.

### FIELD OF THE DISCLOSURE

The present disclosure generally relates to vehicle navigation and, more specifically, to providing a route for a vehicle that takes into account remaining charge of the vehicle, the characteristics of the occupants, and the characteristics of the charging stations.

### BACKGROUND OF THE DISCLOSURE

Many modern vehicles, especially automobiles, are powered using electric motors and batteries to travel to a specified destination. Many electric vehicles have an energy capacity that provides less than 100 miles of real-world traveling range. As such, plug-in hybrid electric vehicles (PHEVs) and all-electric vehicles (EVs) for both consumers and fleet services need access to charging stations. Access to these charging stations is growing with numerous stations open at fleet facilities, workplaces, and public destinations such as park-n-rides and grocery stores, in addition to an individual's home. In addition, the charging equipment for plug-in electric vehicles is classified by the rate at which the batteries are charged. Charging times vary based on how depleted the battery is, how much energy the battery holds, the type of battery, and the type of charging station. This means that the charging time may range from 15 minutes to 20 hours or more, depending on these factors. Because of the large disparity in charging times, it is difficult for vehicle owners to confidently plan a route so as to not run out of charge. To compensate for the difficulty in ascertaining charging locations and the amount of time it takes to charge a vehicle, some charging stations offer a battery swap that will swap out your depleted battery for a fresh, fully charged battery in less than 15 minutes. Thus, depending on the services and infrastructure, the time to charge can vary drastically. When using an EV or a PHEV for planned activities, it would be helpful to know in advance the services offered at a particular charging station (e.g., battery swap), the cost of charging, the type of charging equipment a particular charging station has, and the estimated time to charge a particular battery, as well as any characteristics an occupant has that might affect the route.

### SUMMARY OF THE DISCLOSURE

The following presents a simplified summary of one or more examples in order to provide a basic understanding of the disclosure. This summary is not an extensive overview of all contemplated examples, and is not intended to either identify key or critical elements of all examples or delineate the scope of any or all examples. Its purpose is to present some concepts of one or more examples in a simplified form as a prelude to the more detailed description that is presented below.

Some examples are directed to a method of determining a route for a vehicle, comprising: receiving a specified destination for the vehicle; obtaining a remaining charge of a battery for the vehicle; identifying one or more present occupants of the vehicle; obtaining one or more characteristics of the one or more present occupants; identifying one or more charging stations located between a present location of the vehicle and the specified destination; obtaining one or more characteristics of the one or more charging stations; and automatically determining, using one or more processors, a route for the vehicle to the specified destination based on the remaining charge of the battery, the one or more characteristics of the one or more present occupants, and the one or more characteristics of the one or more charging stations.

Some examples are directed to a system for determining a route for a vehicle, comprising: one or more processors; and a memory including instructions, which when executed by the one or more processors, cause the one or more processors to perform a method comprising: receiving a specified destination for the vehicle; obtaining remaining charge of a battery of the vehicle; identifying one or more present occupants of the vehicle; obtaining one or more characteristics of the one or more occupants; identifying one or more charging stations located between present location of the vehicle and the specified destination; obtaining one or more characteristics of the one or more charging stations; and determining a route for the vehicle to the specified destination based on the remaining charge of the battery, the one or more characteristics of the one or more present occupants, and the one or more characteristics of the one or more charging stations.

Some examples are directed to a non-transitory computer-readable medium including instructions, which when executed by one or more processors, cause the one or more processors to perform a method comprising: receiving a specified destination for the vehicle; obtaining remaining charge of a battery of the vehicle; identifying one or more present occupants of the vehicle; obtaining one or more characteristics of the one or more occupants; identifying one or more charging stations located between present location of the vehicle and the specified destination; obtaining one or more characteristics of the one or more charging stations; and determining a route for the vehicle to the specified destination based on the remaining charge of the battery, the one or more characteristics of the one or more present occupants, and the one or more characteristics of the one or more charging stations.

### BRIEF DESCRIPTION OF THE DRAWINGS

For a better understanding of the various described aspects, reference should be made to the description below, in conjunction with the following figures in which like-referenced numerals refer to corresponding parts throughout the figures.

FIG. 1 illustrates an exemplary dashboard with integrated features of the intelligent route planning system.

FIG. 2A is a display illustrating an example of a route generated from the intelligent route planning system.

FIG. 2B is a display illustrating an example of a route generated from the intelligent route planning system.

FIG. 2C is a display illustrating an example of a route generated from the intelligent route planning system with multiple destinations.

FIG. 2D is a display illustrating an example of a route generated from the intelligent route planning system without a specified destination.

FIG. 3 illustrates an exemplary process for determining a route according to the examples of the disclosure.

FIG. 4 illustrates an exemplary process of optional enhancements for determining a route according to the examples of the disclosure.

FIG. 5 illustrates a system block diagram of a vehicle control system according to examples of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Examples of network systems will now be presented with reference to various elements of apparatus and methods. These apparatus and methods will be described in the following detailed description and illustrated in the accompanying drawing by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

The present disclosure describes a system and method for vehicles (e.g., automobiles) that detects and gathers information about a vehicle to determine a route that accounts for charging the vehicle, especially; accounting for services offered at a particular charging station (e.g., battery swap), the cost of charging, the type of charging equipment a particular charging station has, estimated time to charge a particular battery, as well as any one or more characteristics of the occupants (e.g., driving habits) have that effect the route. The examples presented herein are directed for determining a route for a vehicle. The system can be integrated with status indicators of a vehicles dashboard to include alerts and vehicle status; such as remaining charge, estimated distance to a specified destination, estimated range of remaining charge, etc. The system can include a display integrated into the vehicles dashboard. The system can also include a mobile device (e.g., tablet, smart phone) that interfaces with aspects of the system. The system is configured to obtain remaining charge of a battery, identify present occupants of the vehicle, obtain characteristics of the occupants, identify charging stations located between present location of the vehicle and the specified destination, obtain characteristics of the charging stations, and determine a route for the vehicle to the specified destination based on the remaining charge of the battery, the characteristics of the present occupants, and the characteristics of the charging stations.

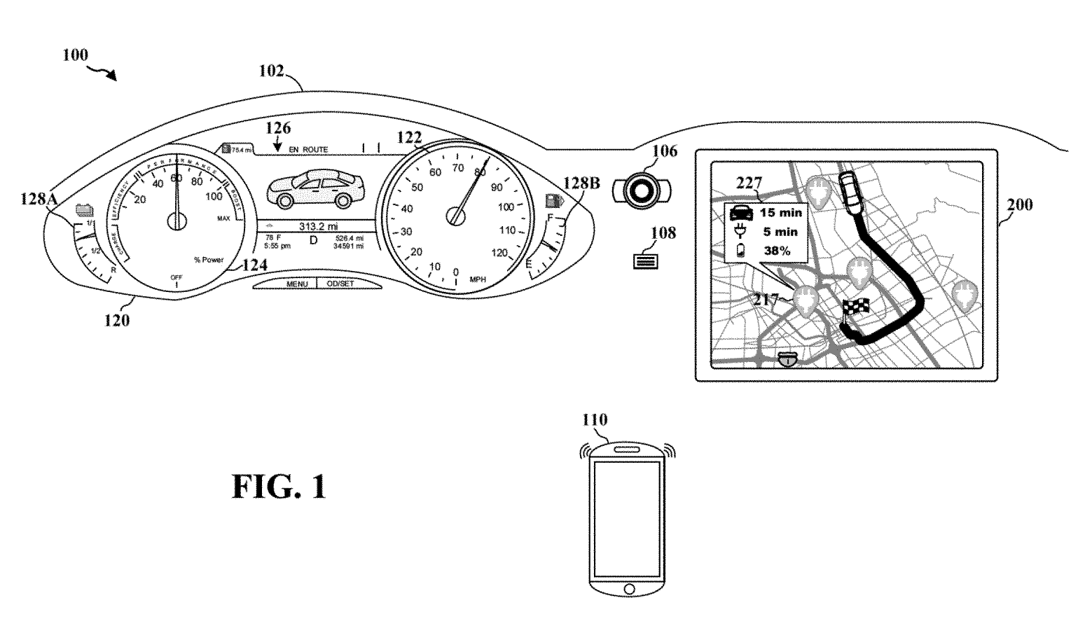

FIG. 1 illustrates an exemplary dashboard 102 with integrated features of the intelligent route planning system 100. Dashboard 102 can include an indicator console 120, one or more sensors (e.g. camera 106, microphone 108), and a display 200. As depicted, the indicator console 120 includes indicators for the status of the vehicle, such as a speedometer 122, a power gage 124, a vehicle status panel 126, a battery charge gauge 128A, and a fossil fuel gauge 128B. The vehicle status panel 126 can be configured to include some aspects that are also presented for display in display 200 such as; alerts, (e.g., insufficient charge alert 241, low charge alert 242, etc.) as well as the remaining charge, estimated distance to destination, estimated range of remaining charge, and the like.

Display 200 can be an LCD display, plasma screen, LED, organic LED (OLED), heads-up-display (HUD), and the like. In some examples, display 200 is a touchscreen display capable of receiving input from an occupant of the vehicle. As such, the occupant can touch various symbols and icons on the display 200 to hide or view additional information. For example, an occupant can touch the icon for charging station 217 to view or hide the status information block 227.

Camera 106 can be integrated into the dashboard 102 as part of the route planning system 100. In particular, camera 106 is capable of capturing image data (e.g., video data), in order to identify one or more occupants of the vehicle. For example, an occupant's facial profile can be within view of camera 106 while the occupant is interfacing with the display 200. The camera 106 can capture the image of the occupant's profile that can be processed using facial recognition to automatically identify the occupant of the vehicle.

Microphone 108 can also be integrated into the dashboard 102 as part of the route planning system 100. Microphone 108 is capable of capturing voice data (e.g., audio data) that can interface with the route planning system 100 as well as be used to automatically identify an occupant of the vehicle. Microphone 108 can capture the audio data from an occupant that can be used to issue vocal commands to the route planning system 100 (e.g., “select destination” commands for the route planning system 100 to select a new destination). Further, the captured voice data can be used in speech recognition to automatically identify the occupant of the vehicle.

Mobile device 110 is an optional component of the route planning system 100 that can also be integrated into the dashboard. For example, in some instances, mobile device 110 can be a tablet configured with a docking station in the dashboard. In some instances, the tablet/docking station can be used interchangeably with display 200. In some instances, mobile device 110 is configured to interface with the route planning system 100. For example, the mobile device can include a calendar application that synchronizes with the route planning system 100 and automatically provides the occupant's identity and scheduled appointments with the specified destinations and associated timeframes.

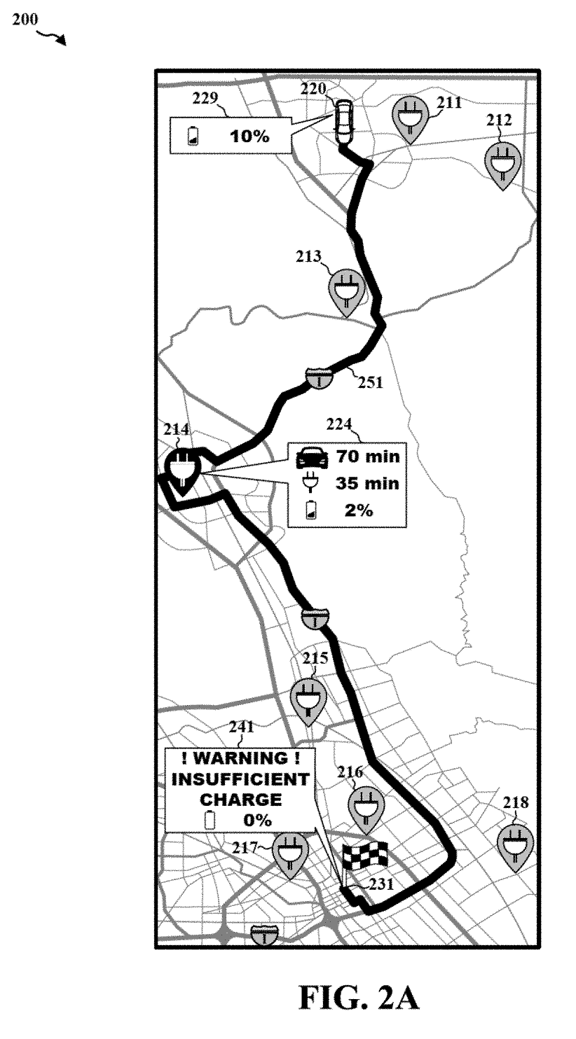

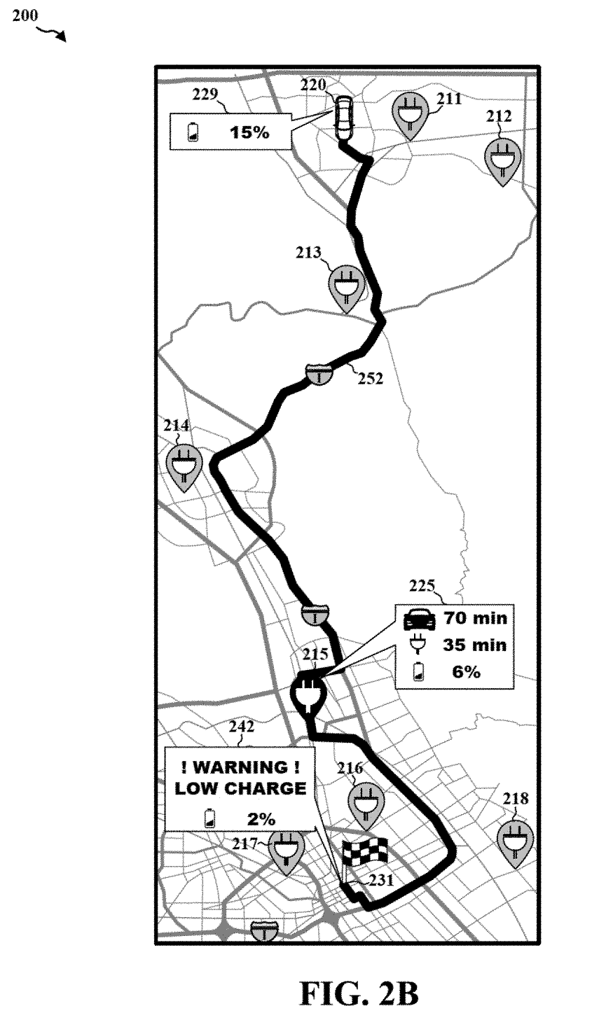

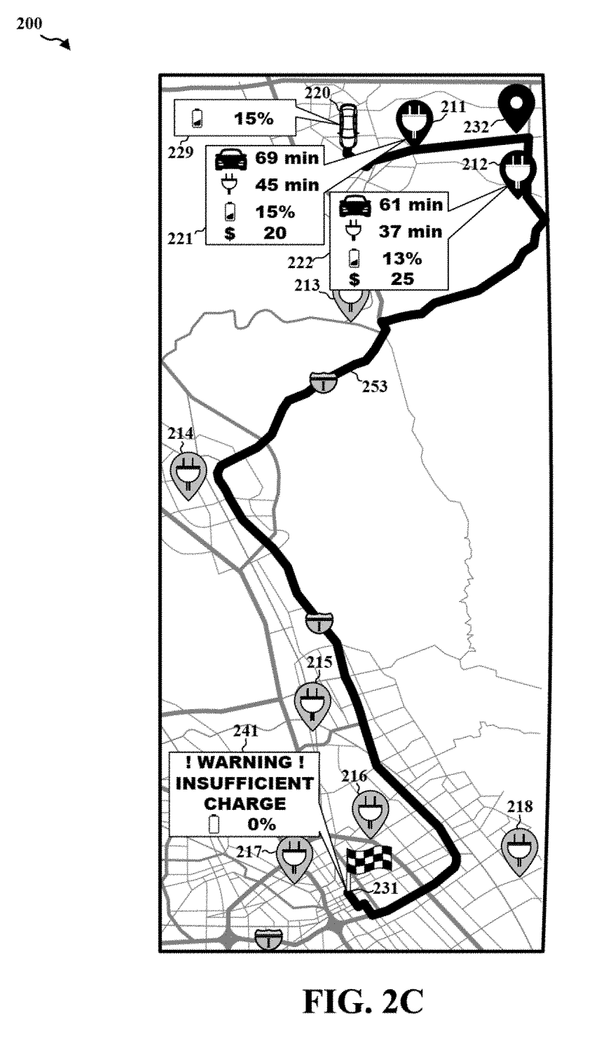

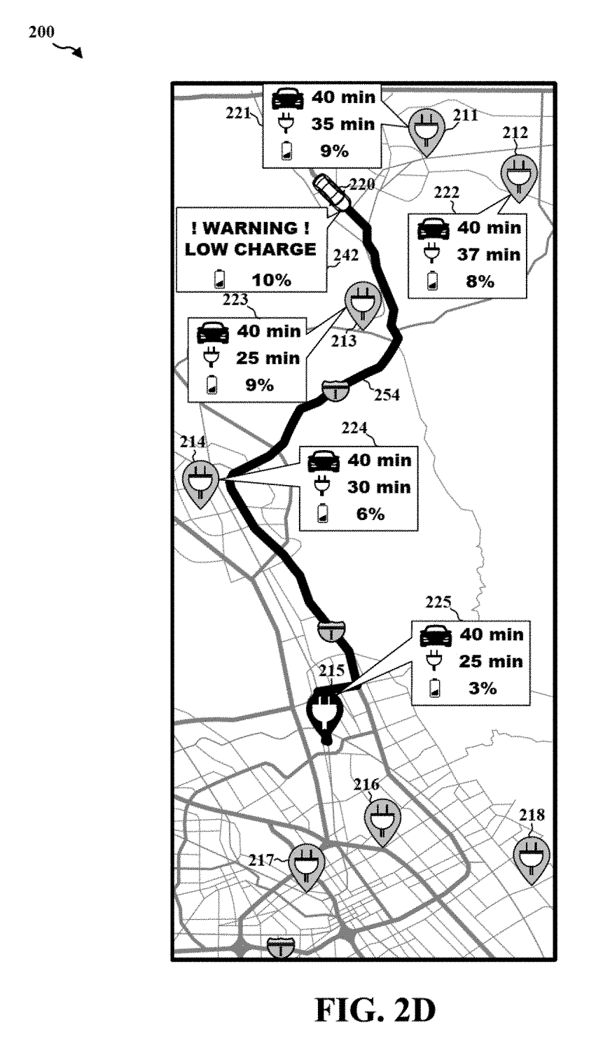

FIG. 2A is a display illustrating an example of a route generated from the intelligent route planning system 100. In this example, an occupant has specified a destination and the intelligent route planning system 100 determines that the remaining charge of the battery is estimated to have insufficient charge to reach the specified destination. The intelligent route planning system 100 alerts the occupant (e.g., insufficient charge alert 241) that it is estimated that there is an insufficient amount of charge to reach the specified destination. In some examples, the insufficient charge alert 241 is a prompt on display 200 along with the navigation map, as depicted in FIG. 2A. In other examples, the insufficient charge alert 241 is an indicator integrated in to the dashboard 102 of vehicle 220.

The intelligent route planning system 100 identifies charging stations 211-218 that are between (or in proximity to) the selected route 251, as depicted in FIG. 2A. The intelligent route planning system 100 detects and/or gathers information related to the remaining charge of the battery, the characteristics of the occupant, and the characteristics of the charging stations in order to make an informed decision. To obtain the remaining charge of the battery, vehicle 220 is equipped with a voltage sensor that detects the output voltage. In some examples, vehicle 220 is equipped with a current sensor that detects the output current from the battery. Further, in some examples, vehicle 220 logs the output current with the output voltage to memory. The combination of output current and the output voltage provides the output power.

By tracking the output current and output voltage, intelligent route planning system 100 can track and profile (e.g., voltage/current profile) the battery for both maintenance purposes as well as provide an indicator of power capacity (e.g., old batteries tend to have lower energy storage capacity). In some examples, the output current and output voltage tracking is associated with location (e.g., GPS coordinates). This association provides additional information that can be used for estimating the remaining charge on the battery along routes. That said, status information block 224 of FIG. 2A can provide higher accuracy for the remaining charge when provided with a database of output current and output voltage associated with locations along route 251.

To obtain characteristics of the occupant the intelligent route planning system 100 first identifies the occupant. In some examples, the intelligent route planning system 100 uses camera 106 to capture video images of the occupant and implements facial recognition to identify the occupant. In other examples, intelligent route planning system 100 uses microphone 108 to detect and capture the occupant's voice and implements voice or speech recognition to identify the occupant. It should be appreciated that other ways of identifying the occupant can be implemented. For example, the route planning system 100 can synchronize with one or more applications on the occupant's mobile device that are configured to provide an occupant's identity as well as identity data (e.g., calendar information). Other ways of identifying include; fob, access card, and manually interfacing with the vehicles 220 computer. Added security can be implemented to positively identify an occupant such as fingerprint scan with fingerprint recognition or retina scan with retinal recognition.

Once the occupant has been identified, in some examples, the intelligent route planning system 100 searches a database (e.g., cloud, storage 512) for characteristics of the present occupants. It should be appreciated that an occupant can be a driver and/or passenger(s) or in the case of an autonomous vehicle (all passengers). As such, the characteristics of the occupant(s) can vary. For example, in one instance, the characteristics of the present occupants can be each occupant's weight, which the intelligent route planning system 100 can use for a more accurate estimate of the status of the remaining battery charge (e.g., as provided in status information block 224 of FIG. 2A). Further, the intelligent route planning system 100 can determine patterns associated with the characteristics of the present occupants. For example, in one instance, the intelligent route planning system 100 can identify the driver (for non-autonomous vehicles), search the database, and determine that a particular driver has certain driving characteristics (e.g., driving habits) where the driver tends to accelerate and brake (e.g., heavy on acceleration and braking) when compared to an average driver (e.g., averaged from the database). This increase in frequency of accelerating and braking can decrease efficiency, which reduces the overall range of the vehicle 220. As such, the intelligent route planning system 100 can estimate a slightly lower remaining battery charge (e.g., as provided in status information block 224 of FIG. 2A). In some examples, the intelligent route planning system 100 searches a database (e.g., cloud, storage 512) for characteristics of the present occupants that relates to charging patterns (e.g., charging locations, charging time etc.). For example, an occupant can frequent a specific charging station at specific time in a predictable pattern. As such, the intelligent route planning system 100 can automatically specify a destination to a charging station based on the present occupant's charging patterns.

To obtain characteristics of the charging stations the intelligent route planning system 100 retrieves capabilities and/or features for each of the charging stations. For example, in some instances, the intelligent route planning system 100 interfaces and searches a database (e.g., cloud) for; charging costs, wait times, compatibility, and the like, for each identified charging station. These databases can be in a cloud that is updated by the charging stations or information services (e.g., paid information service, mobile app).

Referring to FIG. 2A, the route planning system 100 automatically determines that charging station 214 is the top choice for charging based on the gathered information associated with the remaining charge of the battery, the characteristics of the occupants, and the characteristics of the charging stations. It should be appreciated that in some examples, the route planning system 100 estimates the status of the vehicle at future locations based on the remaining charge of the battery, the characteristics of the occupants, and the characteristics of the charging stations. As depicted in status information block 224, the route planning system 100 estimates that the total travel time to reach the destination is 70 minutes, the charging time is estimated to take 35 minutes (including wait time), and the battery is estimated to arrive at charging station 214 with 2% charge remaining.

FIG. 2B is a display illustrating an example of a route generated using the intelligent route planning system 100. In this example, an occupant has been identified and has specified a destination. The intelligent route planning system 100 determines that the battery is estimated to have sufficient charge to reach the specified destination and will arrive with an estimated 2% charge. However, the estimated remaining charge is below a charge threshold (e.g., 10%). As such, the intelligent route planning system 100 alerts the occupant of a low charge and displays an estimated remaining charge of the battery at the specified destination. In some examples, the low charge is a status alert marked at the specified destination, as depicted in FIG. 2B. In some examples, the low charge alert 242 is a marker positioned at the location along the route where it is estimated that the charge drops below the charge threshold. It should be appreciated that the low charge alert can be alert forms other than the low charge alert 242 presented on display 200 along with the navigation map, depicted in FIG. 2B. For example, in some examples, the low charge alert 242 is integrated into the dashboard 102. In other examples, the low charge alert 242 is an audio sound, or a tactile vibration.

As depicted in FIG. 2B, the route planning system 100 automatically determines that charging station 215 is the top choice for charging and selects route 252. In this instance, the status information block 229 shows that vehicle 220 along route 252 has a slightly higher remaining charge of the battery than vehicle 220 along route 251 (FIG. 2A). As such, the route planning system 100 determines that vehicle 220 depicted in FIG. 2B is capable of traveling further to charging station 215 without running out of charge and selects charging station 215 over charging station 214. It should be appreciated that in some examples, the route planning system 100 can weigh the characteristics of the occupant and the charging stations when determining a preference for charging station 215 over charging station 214. It should also be appreciated that in such examples, the occupant can adjust the weight given to each of these characteristics. For instance, in some instances, the route planning system 100 can place more weight on the cost charging station 215 charges for the charging. In some instances, more weight can be placed on an occupants charging pattern and/or driving pattern. For example, the route planning system 100 can track charging locations and associate the charging location with occupants that over time, can heuristically determine a route pattern in which an occupant tends to charge at certain charge stations. In some examples, the route planning system 100 determines a route pattern based on the route adjustments. In some examples, the route planning system 100 determines a route based on time of day or day of the week. In some examples, the route planning system 100 aggregates the charging locations and determines a pattern based on the most frequented. For instance, in some examples, more weight can be placed on wait time. For instance, in some examples, the reason route planning system 100 selects charging station 215 over charging station 214 because charging station 215 has a shorter wait time or has a shorter average wait time based on historical data.

FIG. 2C is a display illustrating an example of a route generated using the intelligent route planning system 100 with multiple destinations. In this example, an occupant has been identified and has specified a first destination 232 followed by a final destination 231. As in FIG. 2A, the intelligent route planning system 100 determines that the remaining charge of the battery is estimated to have insufficient charge to reach the specified destination. As such, the intelligent route planning system 100 alerts the occupant (e.g., insufficient charge alert 241) that it is estimated that there is an insufficient amount of charge to reach the specified destination. As depicted in FIG. 2C, charging station 211 is estimated to cost less than charging station 212. For instances where the intelligent route planning system 100 is configured to place more weight on the cost, the intelligent route planning system 100 will determine a route to charging station 211 over charging station 212.

In some examples, the route planning system 100 can synchronize with one or more applications on the occupant's mobile device (e.g., using mobile device 110) that are configured to provide information regarding occupant's appointments (e.g., calendar) to determine whether there is sufficient time for the wait times at certain charging stations. For instance, after synchronizing with the occupant's calendar on a mobile device 110, the route planning system 100 extracts the locations and times for the upcoming events.

As depicted in FIG. 2C, the route planning system 100 selects first destination 232 corresponding to a first appointment and final destination 231 corresponding to a second appointment, determines that there is insufficient charge to reach the final destination, and alerts the occupant (e.g., insufficient charge alert 241). Based on the appointment information extracted from the occupant's calendar on a mobile device 110, the route planning system 100 can charge before the first appointment or after the first appointment. If the route planning system 100 determines that there is sufficient time to charge before the first appointment, the route planning system 100 can determine a route 253 that stops at station 211 to charge prior to the first appointment. If the route planning system 100 determines that there is insufficient time to charge before the first appointment but sufficient time after the first appointment, the route planning system 100 can determine a route 253 that forgoes station 211 and instead stops at station 212 to charge after the first appointment. If the route planning system 100 determines that there is insufficient time for charging before the first appointment and after the first appointment, the route planning system 100 can request a replacement vehicle (e.g., fleet-type vehicle).

In some instances, when the vehicles is an autonomous vehicle capable of driving to a selected destination without a driver and the duration of the first appointment is above a time threshold, vehicle 220 can be charged during the first appointment. In particular, the route planning system 100 can determine a route where the vehicle 220 can drop off occupants at the first destination 232, autonomously travel to charging station 211, and autonomously return to the first destination 232 before the end of the appointed time, whereupon, vehicle 220 and occupants can continue to the final destination 231.

The intelligent route planning system 100 can also obtain en route information and adjusts the route based on the en route information. In some examples, the en route information includes an update of the characteristics of the charging stations. For instance, when pressed for time, intelligent route planning system 100 could have determined a route 253 to station 212, however, after receiving information en route from charging station 211 that indicates wait time has changed to less than that of charging station 212. As such, the intelligent route planning system 100 can adjust route 253 to charge at charging station 211 instead. In some examples, the en route information includes additional information that can be used to assist in determining a route, these include; traffic congestion, terrain, weather conditions, and traffic control mechanisms. For instance, in one example, intelligent route planning system 100 can receive information that indicates the number of stop signs and stop lights along a specific route will significantly delay the arrival time. As such, intelligent route planning system 100 can adjust the route to a longer route with less stop signs and stop lights.

It should be appreciated that the estimates for travel time, charging time, remaining battery charge upon arrival, and cost depicted in any one of the status information blocks 221-225 (FIGS. 2A-2D) can be updated based on en route information.

FIG. 2D is a display illustrating an example of a route generated using the intelligent route planning system 100 without a specified destination. In this example, an occupant is traveling in vehicle 220 while the remaining charge drops below a charge threshold. In such an example, the intelligent route planning system 100 alerts the occupant of low charge (e.g., low charge alert 242) and displays an estimated remaining charge of the battery at the instance of detected low charge. The intelligent route planning system 100 further identifies charging stations 211-215 that are within range of vehicle 220 for charging. In some instances, intelligent route planning system 100 can be configured for the occupant to select the charging station. For instance, in one example, an occupant may already know the route to the specified destination but failed to sufficiently charge the vehicle. As such, along the route the intelligent route planning system 100 alerts the occupant of low charge and prompts the occupant with a list of potential charging stations. In other instances, the list of potential charging stations are prioritized based on the characteristics of the occupants and the characteristics of the charging station. For example, the route planning system 100 can search a database (e.g., cloud, storage 512) for route patterns associated with the occupant (e.g., heuristically determined route patterns) as well as search a database (e.g., cloud, storage 512) for charging costs, wait times, compatibility, and the like, for each identified charging station. Based on occupant patterns and the charge stations charging costs, wait times, manufacture compatibility, etc., the route planning system 100 determines that the charging station 215 is the most favorable charging station. As such the route planning system 100 determines route 254 to the charging station 215 as depicted in FIG. 2D. It should be appreciated that tracking and heuristically determined route patterns can also be applied to the examples depicted in FIG. 2A-2C.

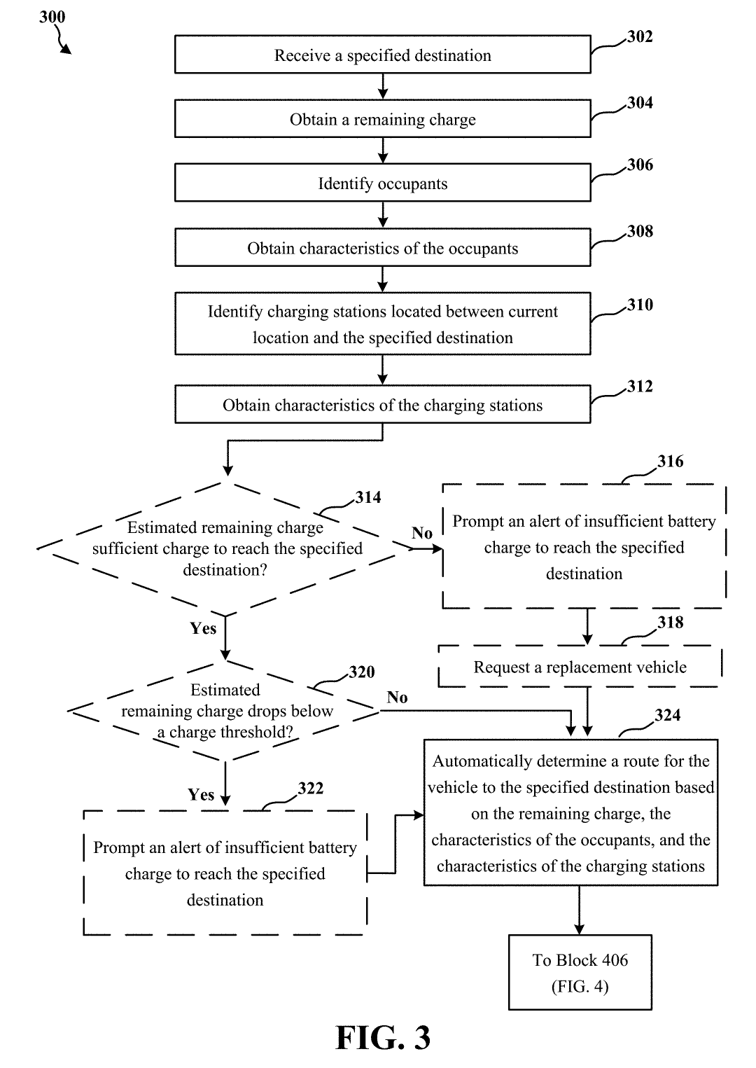

FIG. 3 illustrates an exemplary process 300 for determining a route according to examples of the disclosure. Process 300 can be performed when the vehicle determines a low charge threshold is detected or when an occupant selects a destination and it is determined that the remaining charge of the battery is estimated to be insufficient to reach the specified destination. The method can be performed by an autonomous vehicle or non-autonomous vehicles. In some instances, vehicle 220 is a gas-electric hybrid.

At block 302, vehicle 220 receives a specified destination. In particular, route planning system 100 of vehicle 220 is configured to receive either manually or automatically a specified destination from an occupant. For instance, in some examples, display 200 of vehicle 220 can be a touch display configured for an occupant to manually input the specified destination for route planning system 100. In other instances, the occupant may vocally request a specific location that can be detected via microphone 108 into audio data content. The route planning system 100 can be configured with voice and/or speech recognition capable of extracting the specified destination from the occupant's speech. For example, an occupant can state “select destination Embarcadero San Francisco, Calif.” and the route planning system 100 selects Embarcadero San Francisco, Calif. as the specified destination. In some examples, the input can determine the specified destination heuristically. For example, the vehicle could have frequented Embarcadero in San Francisco. Based on previous locations and or specified destinations the occupant can state “go to embarcadero” and the route planning system 100 selects Embarcadero San Francisco, Calif. as the specified destination. The vehicle, in particular, the route planning system 100 can receive a specified destination automatically from synchronizing with occupant's mobile device 110. For example, the route planning system 100 can interface with the occupant's mobile device 110 and extracted information (e.g., location and time) regarding a scheduled appointment. As such, the route planning system 100 can compare the current time with the scheduled appointment time to automatically provide the specified destination.

At block 304, vehicle 220 obtains a remaining charge of a battery for the vehicle. In particular, vehicle 220 can be equipped with a voltage sensor that detects the output voltage of the battery. The vehicle 220 can also be equipped with a current sensor that detects the output current from the battery. In some examples, by tracking the output current and output voltage, the intelligent route planning system 100 can track and profile the battery for both maintenance purposes as well as provide an indicator of power capacity (e.g., old batteries tend to have lower energy storage capacity). Based on the detected voltage, current, and voltage/current profile vehicle 220 obtains the remaining charge.

At block 306, vehicle 220 identifies one or more present occupants of the vehicle. In particular, route planning system 100 of vehicle 220 is configured to identify either manually or automatically the present occupant(s) of vehicle 220. For instance, in some examples, display 200 of vehicle 220 can be a touch display configured for an occupant to manually input the identity of the present occupant. In other instances, the route planning system 100 can detect and capture the occupant's voice and implement voice or speech recognition to automatically identify the occupant(s). In some instances, the occupant(s) can vocally identify themselves using a passcode. In some examples, route planning system 100 of vehicle 220 can use additional techniques to identify occupants, such as a key-fob, access card, fingerprint scan with fingerprint recognition, and/or retina scan with retinal recognition.

At block 308, vehicle 220 obtains one or more characteristics of the one or more present occupants. In particular, the intelligent route planning system 100 of vehicle 220 can search a database (e.g., cloud, storage 512) for information associated with the occupants, the information can include route patterns (e.g., heuristically determined route patterns). In some examples, vehicle 220 obtains interfaces with mobile device 110 and synchronizes with a calendar of the one or more present occupants to obtain the one or more characteristics of the one or more present occupant(s).

At block 310, vehicle 220 identifies one or more charging stations located between the present location of the vehicle and the specified destination. In some instances, the intelligent route planning system 100 of vehicle 220 searches a database (e.g., cloud, storage 512) for charging stations that are located along a shortest route between the present location of the vehicle and the specified destination. In some examples, the search can include charging stations within a specified distance from a point along the shortest route. For example, the intelligent route planning system 100 of vehicle 220 depicts charging stations 211-218 along the routes 251-254 in FIG. 2A-2D. It should be appreciated that each charging station can be adjacent to the determined route rather than precisely in between. Such adjacent charging stations can become candidates for potential charging stops.

At block 312, vehicle 220 obtains one or more characteristics of the one or more charging stations. In some instances, the intelligent route planning system 100 of vehicle 220 retrieves capabilities and/or features for each of the charging stations. For example, the intelligent route planning system 100 of vehicle 220 can connect to a service that provides the cost and wait time associated with each charge station. Such a service can provide additional information such as supported batteries, connector types, facilities (e.g., restrooms, showers, eateries, etc.). In some examples, the one or more characteristics of the one or more charging stations includes a wait time estimate associated with vehicles already scheduled for charging.

At block 314, vehicle 220 determines whether the remaining charge of the battery is estimated to have a sufficient charge to reach the specified destination. That said, in some instances, the intelligent route planning system 100 of vehicle 220 can determine that based on the present location of the vehicle and the specified destination of the vehicle, that the vehicle 220 cannot reach the specified destination without charging. In some examples, the intelligent route planning system 100 of vehicle 220 can calculate the shortest distance between present vehicle location and the specified destination, and determine whether the shortest distance exceeds the estimated range. The intelligent route planning system 100 of vehicle 220 can estimate the range based on terrain, weather conditions, battery status (e.g., measured voltage/current), travel patterns, and the like.

At block 316, vehicle 220 prompts the one or more present occupants of the vehicle with an alert of insufficient battery charge to reach the specified destination, in accordance with a determination that the vehicle is estimated to have an insufficient charge to reach the destination. That is, the intelligent route planning system 100 of vehicle 220 can alert the occupant that there is insufficient battery charge prior to departure. The alert can be a prompt on display 200 or in dashboard 102. For example, FIGS. 2A and 2C display insufficient charge alert 241 and marks it at the specified destination. In some examples, the insufficient charge alert can be marked at the estimated location of ˜0% charge. In some examples, the alert includes a list of charging stations with an estimated time to charge the battery for each charging station. As depicted in FIGS. 2A-2D, the list of charging stations can be visually displayed (e.g., overlaid at actual locations in the map and route). In some examples, a mouse over, or touch from the touch screen at the location of a particular charging station can provide additional information gathered for the particular charging station.

At block 318, vehicle 220, can be configured to request a replacement vehicle in accordance with a determination that the vehicle 220 is estimated to have an insufficient charge to reach the specified destination. For example, if an occupant is pressed for time and cannot stop at a charging station for charging without missing (e.g., being late) for an appointment, the intelligent route planning system 100 of vehicle 220 can schedule a replacement vehicle from a fleet service and determine a rendezvous for vehicle exchange. In some examples, each vehicle is autonomous. In such an example, the replacement vehicle can autonomously rendezvous with the occupant's vehicle 220 whereby the occupant's vehicle can autonomously travel to a charging station and schedule a later rendezvous with the occupant.

At block 320, vehicle 220 determines whether the remaining charge of the battery is estimated to drop below a charge threshold in accordance with a determination that the vehicle is estimated to have a sufficient charge to reach the destination. In this example, the vehicle 220 is estimated to sufficient charge to reach the specified destination, however, the charge may be too low for the vehicle 220 to reach a charging station afterwards. For instance, the example depicted in FIG. 2B displays route 252 to include charging station 215 and indicates via low charge alert 242 that vehicle 220 is anticipated to arrive with 2% remaining charge.

At block 322, vehicle 220 prompts the one or more present occupants of the vehicle with an alert that an estimated remaining charge of the battery associated with the selected destination drops below the charge threshold. That is, the intelligent route planning system 100 of vehicle 220 can alert the occupant that the battery charge drops below a threshold prior to departure. The alert can be a prompt on display 200 or in dashboard 102. For example, FIG. 2B displays low charge alert 242 and marks it at the specified destination with an estimated charge of 2% upon arrival. In some examples, the low charge alert can be marked at the estimated location of the low charge threshold (e.g., <10% charge).

At block 324, vehicle 220 automatically determines (e.g., using one or more processors) a route for the vehicle to the specified destination based on the remaining charge of the battery, the one or more characteristics of the one or more present occupants, and the one or more characteristics of the one or more charging stations. As depicted in the examples of FIGS. 2A and 2B, the routes can change based on the status of the battery (e.g., 15% remaining vs. 10% remaining). It should be appreciated that, although not expressly depicted, variations on route 251 and 252 (FIG. 2A and FIG. 2B) could change based on charging station characteristics. For example, if charging station 213 is significantly cheaper than either of charging station 214 and charging station 215, or the wait time, significantly cheaper than either of charging station 214 and charging station 215. Likewise, in some examples, the characteristics of the charging stations include a charging manufacturer, a cost associated with using the charging station, or a capability to interface a charge connector on the vehicle with a charging station. It should also be appreciated that, although not expressly depicted, variations on route 251 and 252 (FIG. 2A and FIG. 2B) could change based on occupant's characteristics. For example, variations on route 251 and 252 (FIG. 2A and FIG. 2B) could change if the occupant tends to prefer charging station 213 if it is significantly cheaper than either of charging station 214 and charging station 215. In some examples, automatically determining a route for the vehicle includes scheduling the route based on the characteristics of the present occupant(s).

In some examples, the one or more characteristics of the one or more present occupants include an age of the one or more present occupants. In some examples, the intelligent route planning system 100 determines whether the ages of the one or more present occupant is below an age threshold. In particular, infants and young children have different needs than adults and often want more stops. As such, the intelligent route planning system 100 of vehicle 220 can be configured for age sensitivities such as rest breaks for young children and elderly. In some examples, the intelligent route planning system 100 can optionally identify one or more rest stops in accordance with a determination that the ages of the one or more present occupants is below the age threshold. For example, an occupant in vehicle 220 can be a three-year-old child. As such, the intelligent route planning system 100 of vehicle 220 determines a route that arrives at one or more rest stops. In some examples, a log of previous stops along a route to the specified destination can be included to heuristically determine the rest stops. Further, the intelligent route planning system 100 of vehicle 220 can search for ratings (e.g., one-star, two-star, three-star, four-star, five-star, etc.) and place weight on the rating of a particular rest stop when determining the route.

Further, in some examples, the route for vehicle 220 includes one or more charging stops at the one or more charging stations. For instance, the specified destination can be distances that exceed two or three times the estimated range of the vehicle at full charge (e.g., 100% charge remaining). In such instances, the intelligent route planning system 100 of vehicle 220 can schedule multiple charging stops to reach the specified destination. In some examples, at least one of the one or more charging stops at the one or more charging stations includes partially charging the battery at two or more different charging stations. For instance, final destination 231 can be the occupant's residence and, as depicted in FIGS. 2A and 2B the vehicle 220, has insufficient charge to reach the occupant's residence. In this example, the occupant can stop at charging station 214 or 215 and charge the battery with sufficient charge to make it the rest of the way.

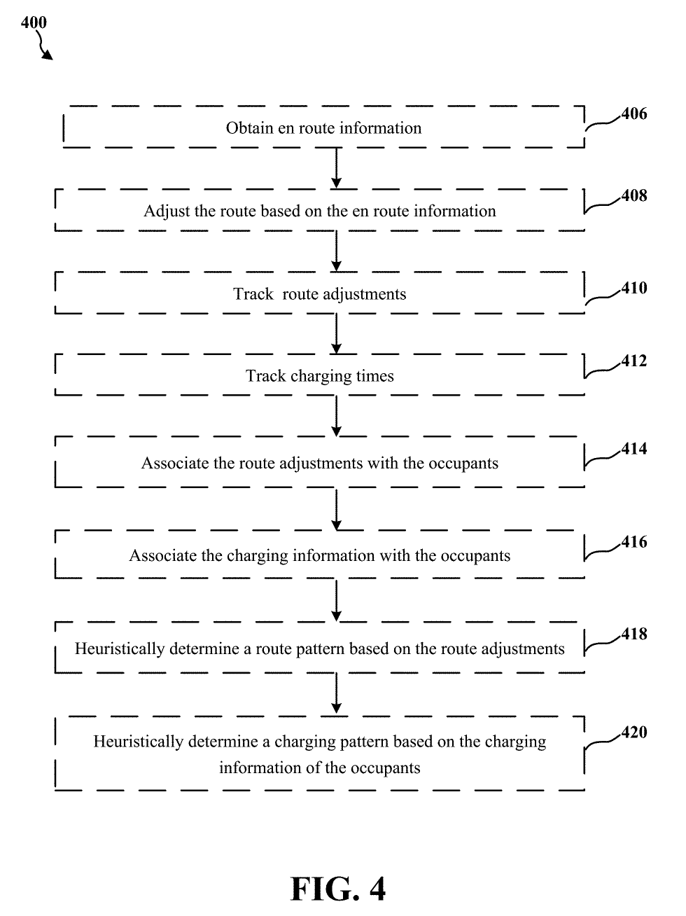

FIG. 4 illustrates an exemplary process 400 of optional enhancements for determining a route according to examples of the disclosure.

At block 406, vehicle 220 can optionally obtain en route information. In particular, the en route information can include an update of the characteristics of the charging stations. For example, vehicle 220 can be en route to final destination 231 as depicted in FIG. 2B and stop at charging station 215. The intelligent route planning system 100 of vehicle 220 receives an update from both charging station 214 and charging station 215 that indicates that charging station 214 has less wait time than charging station 215. In some examples, the en route information includes any one of traffic congestion, terrain, weather conditions, and traffic control mechanisms and the like. In some examples, the en route information includes an update of the characteristics of the charging station.

At block 408 vehicle 220 can optionally adjust the route based on the en route information. In the above example, the intelligent route planning system 100 of vehicle 220 receives an update from both charging station 214 and charging station 215 that indicates that charging station 214 has less wait time than charging station 215. In such an example, the intelligent route planning system 100 can adjust from route 252 to route 253 to stop at charge at charging station 214 instead. In some examples, the en route information can further include traffic congestion, terrain, weather conditions, and traffic control mechanisms. In some example, the adjusting the route includes adjusting wait time or cost information for the charging stations.

At block 410, vehicle 220 can optionally track adjustments to the route for the vehicle. That is, the route planning system 100 of vehicle 220 can track changes from a planned route to an actual route. For example, an occupant may prefer traveling certain routes and the route planning system 100 of vehicle 220 can log the differences for further pattern analysis.

Likewise, at block 412, vehicle 220 can optionally track charging times. For example, the route planning system 100 of vehicle 220 can track charging locations. That is, the tracked changes can heuristically determine a route pattern in which an occupant tends to charge at certain charge stations.

At block 414, vehicle 220 can optionally associate the route adjustments with the present occupants. In particular, the characteristics of the present occupants include the route adjustments. For example, the route planning system 100 of vehicle 220 can link the route adjustments to a database with the occupants.

At block 416, vehicle 220 can optionally associate the charging times with the one or more present occupants. In particular, the characteristics of the present occupants include the charging times. For example, the route planning system 100 of vehicle 220 can link the charging times and the charging locations in a database with the occupants. As such, frequency of an occupant's charging times and the charging locations can assist in placing weight on routes.

At block 418, vehicle 220 can heuristically determine a route pattern based on the route adjustments. As such, the route pattern determined by route planning system 100 of vehicle 220 can place weight on some routes when automatically determining a route for the vehicle to the specified destination. For example, route planning system 100 of vehicle 220 can contrast the present location and route of vehicle 220 with altered routes and extrapolate patterns. Based on the frequency of alterations, route planning system 100 of vehicle 220 can automatically alter the route in accordance with a route to the specified destination consistent with the pattern.

At block 420, vehicle 220 can heuristically determine a charging time pattern based on the charging times of the present occupant(s). As such, the charging time pattern determined by route planning system 100 of vehicle 220 can place weight on some charging times by some occupants when automatically determining a route for the vehicle to the specified destination. For example, route planning system 100 of vehicle 220 can determine the most frequent time that an occupant charges the vehicle, as well as the location of the most frequent time of charge. If the location and time of the most frequented time and location correlates with a low charge alert 242, then route planning system 100 of vehicle 220 can automatically specify a destination.

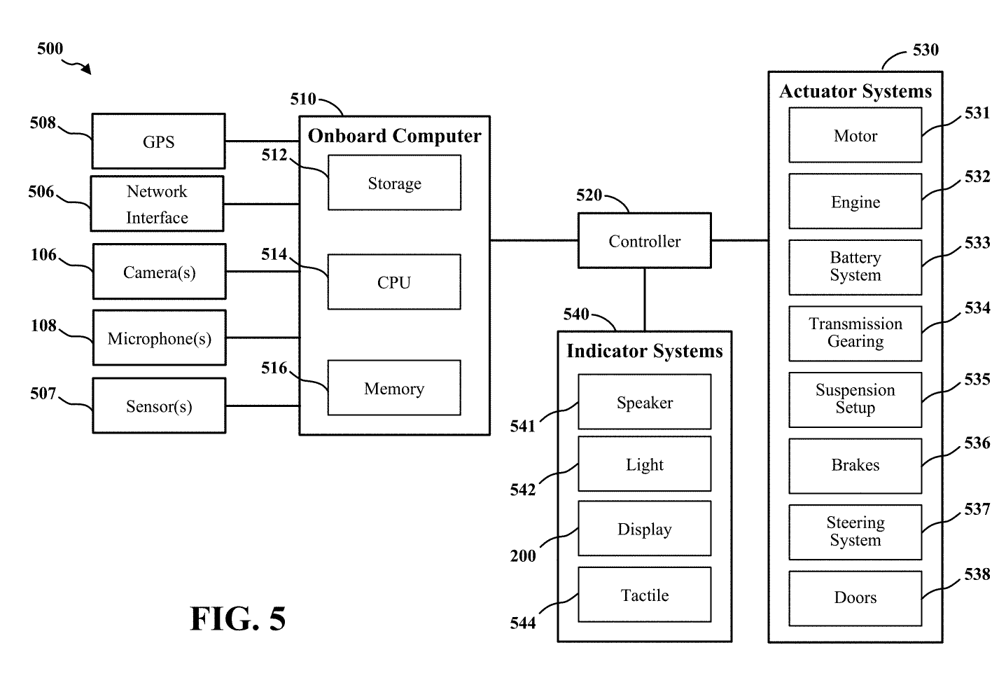

FIG. 5 illustrates a system block diagram of vehicle control system 500 according to examples of the disclosure. Vehicle control system 500 can perform any of the methods described with reference to FIGS. 2-5. System 500 can be incorporated into a vehicle, such as a consumer automobile. Other example vehicles that may incorporate the system 500 include, without limitation, airplanes, boats, or industrial automobiles. Vehicle control system 500 can include a Global Positioning System (GPS) receiver 508 capable of determining the location of the vehicle the position and/or time information of the vehicle. Vehicle control system 500 can include a network interface 506 capable of receiving wireless data (e.g., LTE, WiFi, etc.) that provides position and/or time information of the vehicle as well as information regarding charging stations. Vehicle control system 500 can include one or more cameras 106 capable of capturing image data (e.g., video data), in order to identify one or more occupants of the vehicle. Vehicle control system 500 can include one or more microphones 108 capable of capturing voice data (e.g., audio data) in order to identify one or more occupants of the vehicle. Vehicle control system 500 can also include one or more other sensors 507 (e.g., key-fob sensor, fingerprint sensor, LIDAR, RADAR, etc.) capable of detecting occupants and objects in and around the vehicle and in the vehicle's surroundings. Vehicle control system 500 can include an on-board computer 510 coupled to the cameras 106, microphone 108, and sensors 507, capable of receiving the image data from the camera, audio data from microphone 108, and/or outputs from the sensors 507. The on-board computer 510 can be capable of determining a route for the vehicle to a destination based on the remaining charge of the battery, the one or more characteristics of one or more occupants, and the one or more characteristics of one or more charging stations. On-board computer 510 can include storage 512, memory 516, and a processor 514. Processor 514 can perform any of the methods described with reference to FIGS. 2-5. Additionally, storage 512 and/or memory 516 can store data and instructions for performing any of the methods described with reference to FIGS. 2-5. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation, such as providing an indication to a driver based on the determinations of the on-board computer 510.

It is understood that the specific order or hierarchy of blocks in the processes and/or flowcharts disclosed is an illustration of exemplary approaches. Based upon design preferences, it is understood that the specific order or hierarchy of blocks in the processes and/or flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but are to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any example described herein as “exemplary” is not necessarily to be construed as preferred or advantageous over other examples. The words “module,” “mechanism,” “element,” “device,” and the like may not be a substitute for the word “means.” As such, no claim element is to be construed under 35 U.S.C § 112(f) unless the element is expressly recited using the phrase “means for.”

What is claimed is:

1. A method of determining a route for a vehicle, comprising:
receiving a specified destination for the vehicle;
obtaining a remaining charge of a battery for the vehicle;
identifying one or more present occupants of the vehicle;
obtaining one or more characteristics of the one or more present occupants;
identifying one or more charging stations located between a present location of the vehicle and the specified destination;
obtaining one or more characteristics of the one or more charging stations; and
automatically determining, using one or more processors, a route for the vehicle to the specified destination based on the remaining charge of the battery, the one or more characteristics of the one or more present occupants, and the one or more characteristics of the one or more charging stations.

2. The method of claim 1, further comprising:
determining whether the remaining charge of the battery is estimated to have a sufficient charge to reach the specified destination; and
in accordance with a determination that the vehicle is estimated to have an insufficient charge to reach the destination, prompting the one or more present occupants of the vehicle with an alert of insufficient battery charge to reach the specified destination.

3. The method of claim 2, wherein the one or more characteristics of the one or more charging stations includes a wait time estimate associated with vehicles already scheduled for charging.

4. The method of claim 2, wherein the alert includes a list of charging stations with an estimated time to charge the battery for each charging station.

5. The method of claim 2, further comprising:
in accordance with a determination that the vehicle is estimated to have an insufficient charge to reach the specified destination, requesting a replacement vehicle.

6. The method of claim 2, further comprising:
in accordance with a determination that the vehicle is estimated to have a sufficient charge to reach the destination, determining whether the remaining charge of the battery is estimated to drop below a charge threshold, and prompting the one or more present occupants of the vehicle with an alert that an estimated remaining charge of the battery associated with the selected destination drops below the charge threshold.

7. The method of claim 1, wherein the one or more characteristics of the one or more charging stations includes a charging manufacturer, a cost associated with using the charging station, or a capability to interface a charge connector on the vehicle with a charging station.

8. The method of claim 1, further comprising:
tracking route adjustments to the route for the vehicle; and
associating the route adjustments with the one or more present occupants, wherein the one or more characteristics of the one or more present occupants includes the route adjustments.

9. The method of claim 8, further comprising:
heuristically determining a route pattern based on the route adjustments, wherein the automatically determining a route for the vehicle to the specified destination is further based on the route pattern.

10. The method of claim 1, further comprising:
tracking charging times;
associating the charging times with the one or more present occupants, wherein the one or more characteristics of the one or more present occupants includes the charging times; and
heuristically determining a charging time pattern based on the charging times of the one or more present occupants.

11. The method of claim 10, wherein the automatically determining a route for the vehicle to the specified destination is further based on the charging time pattern.

12. The method of claim 1, wherein the route for the vehicle includes one or more charging stops at the one or more charging stations.

13. The method of claim 12, wherein at least one of the one or more charging stops at the one or more charging stations includes partially charging the battery at two or more different charging stations.

14. The method of claim 1, wherein the obtaining one or more characteristics of the one or more occupants includes obtaining information from a calendar of the one or more present occupants.

15. The method of claim 1, wherein the one or more characteristics of the one or more present occupants includes an age of the one or more present occupants.

16. The method of claim 15, further comprising:
determining whether the ages of the one or more present occupants is below an age threshold; and
in accordance with a determination that the ages of the one or more present occupants is below the age threshold, identifying one or more rest stops.

17. The method of claim 1, further comprising:
obtaining en route information; and
adjusting the route based on the en route information.

18. The method of claim 17, wherein the en route information includes an update of one or more characteristics of the one or more charging stations, and wherein the adjusting the route includes adjusting wait time or cost information for the one or more charging stations.

19. A system for determining a route for a vehicle, comprising:
one or more processors; and
a memory including instructions, which when executed by the one or more processors, cause the one or more processors to perform a method comprising:
receiving a specified destination for the vehicle;
obtaining remaining charge of a battery of the vehicle;
identifying one or more present occupants of the vehicle;
obtaining one or more characteristics of the one or more occupants;
identifying one or more charging stations located between present location of the vehicle and the specified destination;
obtaining one or more characteristics of the one or more charging stations; and
determining a route for the vehicle to the specified destination based on the remaining charge of the battery, the one or more characteristics of the one or more present occupants, and the one or more characteristics of the one or more charging stations.

20. A non-transitory computer-readable medium including instructions, which when executed by one or more processors, cause the one or more processors to perform a method comprising:
receiving a specified destination for the vehicle;
obtaining remaining charge of a battery of the vehicle;
identifying one or more present occupants of the vehicle;
obtaining one or more characteristics of the one or more occupants;
identifying one or more charging stations located between present location of the vehicle and the specified destination;
obtaining one or more characteristics of the one or more charging stations; and
determining a route for the vehicle to the specified destination based on the remaining charge of the battery, the one or more characteristics of the one or more present occupants, and the one or more characteristics of the one or more charging stations.
